(19) United States
(12) Patent Application Publication
(10) Pub. No.: US 2016/0063637 A1
(43) Pub. Date: Mar. 3, 2016

(54) Method for Gathering Employee Data for Insurance Quote Including Submission and/or Enrollment

(71) Applicants: David A. Nelson, Westlake Village, CA (US); John J. Nelson, Westlake Village, CA (US)

(72) Inventors: David A. Nelson, Westlake Village, CA (US); John J. Nelson, Westlake Village, CA (US)

(21) Appl. No.: 14/473,778

(22) Filed: Aug. 29, 2014

(51) Int. Cl. G06Q 40/08

(52) U.S. Cl. CPC G06Q 40/08

(57) ABSTRACT

A method for gathering employee data for insurance quote including submission and/or enrollment is provided. The method comprising steps for a user providing a website for a specific group in a group insurance comprising a plurality of employees or group of individual employees, the user specifying selected information to be gathered from a group of employees, the user sending a hyperlink information of the website to at least one of the plurality of employees, at least one employee using the hyperlink information to access the website, at least one employee entering the specified information, and a server storing and polling the information, and an administrator of the specific group notifying the user of the completion of information entered by the employees.

### BACKGROUND OF THE INVENTION

The present invention relates to a method for gathering employee data for insurance quote including submission and/or enrollment.

Gathering required information from employees for insurance quote including submission and/or enrollment was important but time-consuming all the time as shown in FIG. 1.

A need for a method for gathering employee data for insurance quote including submission and/or enrollment has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a method for gathering employee data for insurance quote including submission and/or enrollment.

A method for gathering employee data for insurance quote including submission and/or enrollment is provided.

The method comprising steps for: a user providing a website for a specific group in a group insurance comprising a plurality of employees or group of individual employees; the user specifying selected information to be gathered from a group of employees; the user sending a hyperlink information of the website to at least one of the plurality of employees; at least one employee using the hyperlink information to access the website; at least one employee entering the specified information, and a server storing and polling the information; and an administrator of the specific group notifying the user of the completion of information entered by the employees.

In the step for the user's specifying, the selected information to be gathered may be specified using a menu option.

The selected information may comprise a default list of fields including an employee name or identification, an employee age or date of birth, an employee home postal code, and an employee dependent status.

The selected information may further comprise a dependent name, a dependent age or date of birth, and a dependent home postal code.

In the step for the user's sending, the hyperlink information may be sent using email, company intranet, verbal, or memorandum.

In the step for the user's using the hyperlink information, the employee may access the website through Internet using computer or mobile electronic devices.

In the step for each employee's entering, the group of employees does not have a direct access to information stored in the server.

The website may comprise a status page showing a degree of completion of gathering information, which is allowed for the group of employees to access limited information including names and number of dependents entered by each employee.

The administrator may be allowed to enter detailed information for a specific employee.

The user may comprise an agent, a broker, a carrier, and others using the quoting system.

In the step for the administrator's notifying, the notifying may be set automatically.

The notifying may be implemented by clicking a button provided on the status page.

The insurance may comprise a health insurance, ancillary insurance, or other employee benefit.

The method may further comprise a step for the user exporting the entered information.

The method may further comprise a step for the user logging in an external quoting system, submission system, or enrollment system and importing the entered information from the server to the quoting system, submission system, or enrollment system.

The method may further comprise a step for the user to use the gathered data within the said system for the purposes comprising quoting, submitting and/or enrolling employees or individuals for health insurance, ancillary insurance or other employee benefit.

The advantages of the present invention are: (1) the method according to the invention enables the employee to enter the required information for insurance quote directly; and (2) the method for gathering employee data for insurance quote facilitates storing, exporting, importing, and utilizing of the gathered information.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a flowchart showing steps for gathering information according to a prior art;

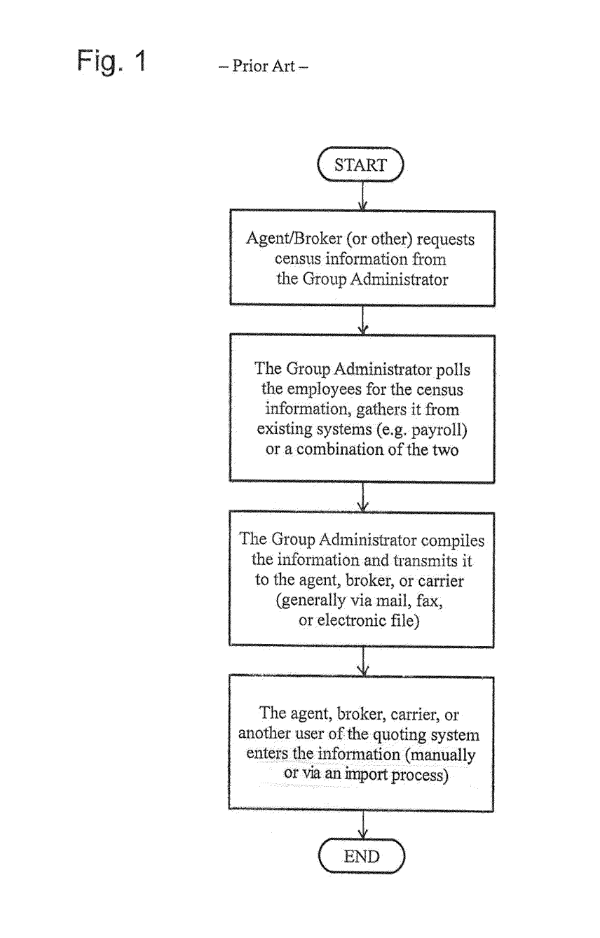

FIG. 2 is a flowchart showing a method for gathering employee data for insurance quote according to an embodiment of the invention;

FIG. 3 is a block diagram performing a method for gathering employee data for insurance quote according to an embodiment of the invention; and

FIG. 4 is a flowchart showing a method for gathering employee data for insurance quote according to another embodiment of the invention.

### DETAILED DESCRIPTION EMBODIMENTS OF THE INVENTION

A method for gathering employee data for insurance quote including, but not limited to, submission and/or enrollment is provided. The method comprising steps for: a user U providing a website 10 for a specific group G in a group insurance comprising a plurality of employees or group of individual employees (S100), wherein the group insurance may or may not be identified or similar; the user U specifying selected information to be gathered from a group of employees G (S100); the user U sending a hyperlink information of the website 10 to at least one of the plurality of employees (S200); at least one employee using the hyperlink information to access the website 10 (S300); at least one employee entering the specified information (S400), and a server 20 storing and polling the information (S500); and an administrator GA of the specific group G notifying the user U of the completion of information entered by the employees (S600).

In the step for the user's specifying (S100), the selected information to be gathered may be specified using a menu option on the website 10.

The selected information may comprise a default list of fields including, but not limited to, an employee name or identification, an employee age or date of birth, an employee home postal code, and an employee dependent status.

The selected information may further comprise a dependent name, a dependent age or date of birth, and a dependent home postal code.

In the step for the user's sending (S200), the hyperlink information may be sent using email, company intranet, verbal, or memorandum or any future form of communication whereby hyperlink information may be sent.

In the step for the user's using the hyperlink information (S300), the employee may access the website 10 through Internet using computer or mobile electronic devices or any future device or method by which Internet may be accessed.

In the step for each employee's entering (S400), the group of employees G does not have a direct access to information stored in the server 20.

The website 10 may comprise a status page showing a degree of completion of gathering information, which is allowed for the group of employees G to access limited information including, but not limited to, names and number of dependents entered by each employee.

The administrator GA may be allowed to enter detailed information for any specific employee.

The user U may comprise an agent, a broker, a carrier, and others using the quoting system.

In the step for the administrator's notifying (S600), the notifying may be set automatically.

The notifying (S600) may be implemented by clicking a button (not shown) provided on the status page.

The insurance may comprise a health insurance, ancillary insurance, or other employee benefit.

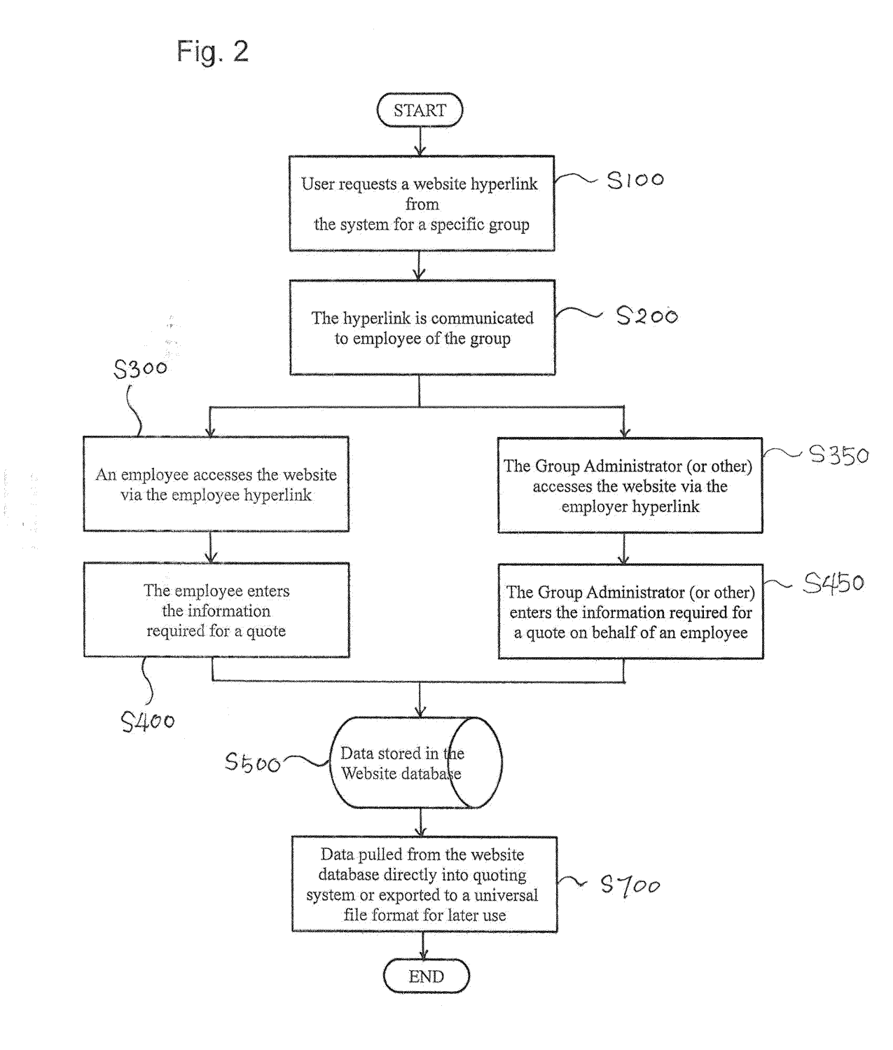

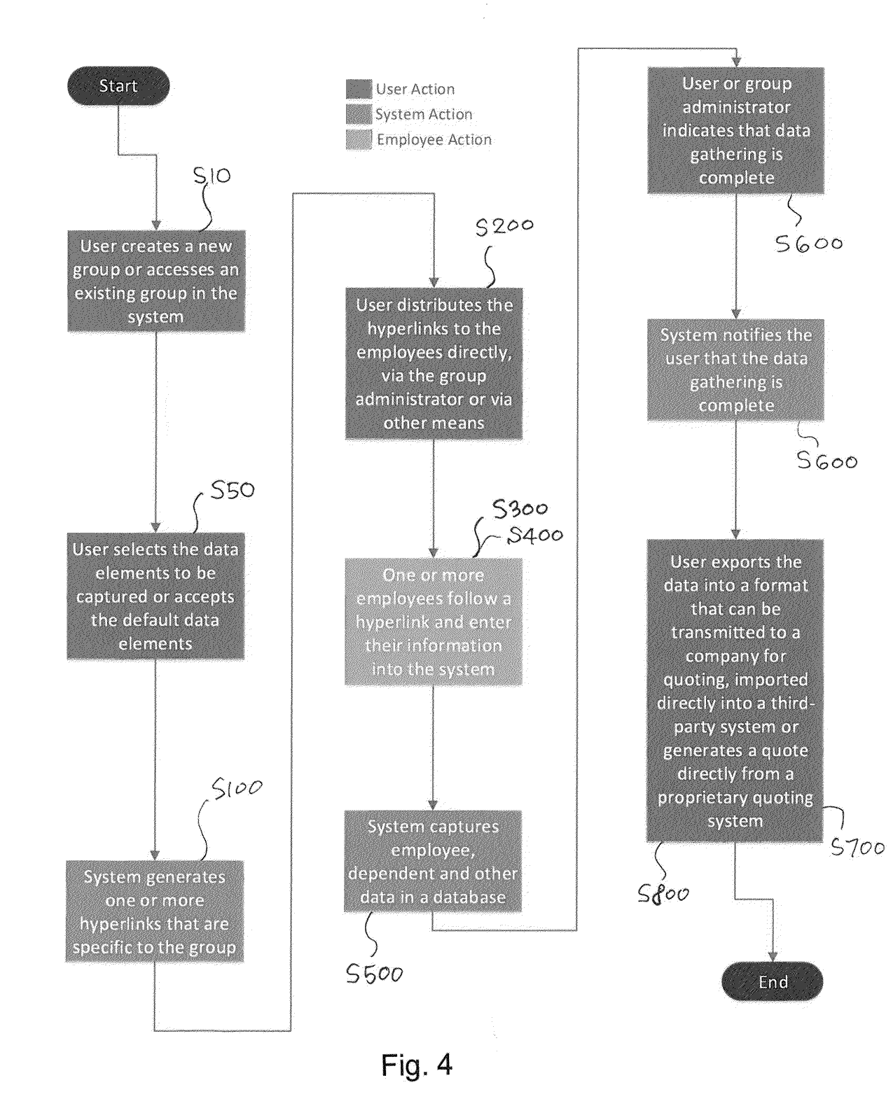

The method may further comprise a step (S700) for the user exporting the entered information as shown in FIGS. 2 and 4.

The method may further comprise a step (S800) for the user logging in an external quoting system 30, submission system, or enrollment system and importing the entered information from the server to the quoting system, submission system, or enrollment system.

The method may further comprise a step (S800) for the user to use the gathered data within the said system for the purposes comprising quoting, submitting and/or enrolling employees or individuals for health insurance, ancillary insurance or other employee benefit.

In certain embodiments of the invention, the administrator (or agent/broker) can enter the detailed information (via the status page) for any employee that does not have access to the internet or otherwise cannot enter the information themselves (S350, S450).

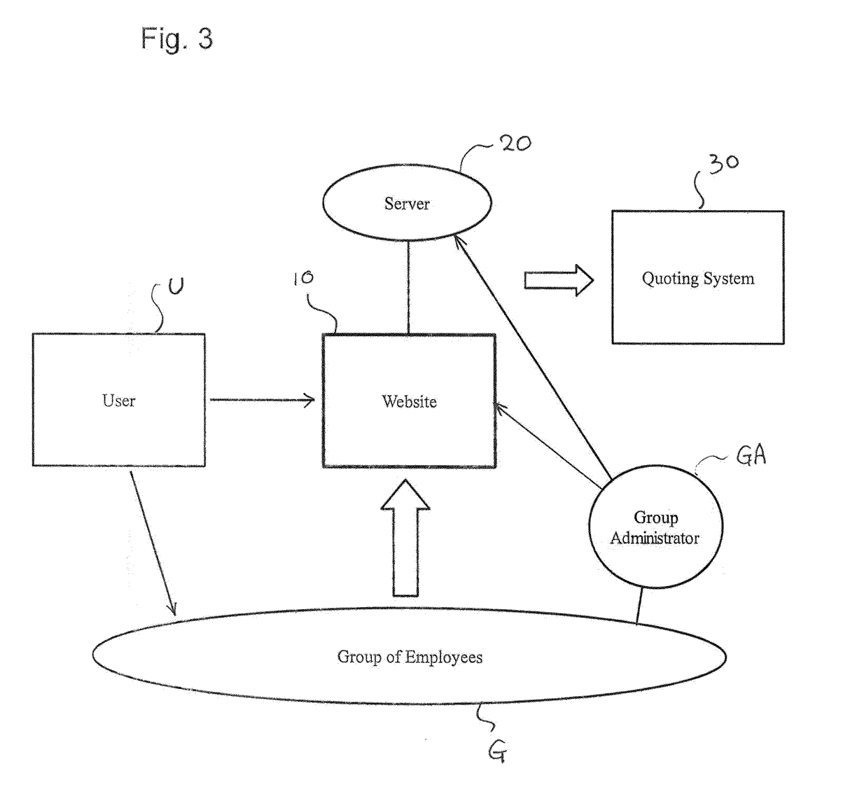

FIG. 3 shows a block diagram of a system performing a method for gathering employee data for insurance quote according to an embodiment of the invention, in which the lines connecting two elements indicate proper electronic connections and the arrows is used for emphasizing just one aspect. That is, commands, data, electronic accesses, etc. are also possible in a direction opposite to the arrow.

In certain embodiments of the invention, as shown in FIG. 4, the method may further comprise a step (S10) for the user creating a new group or accessing an existing group in the system, usually prior to the step (S100).

Still in certain embodiments of the invention, as shown in FIG. 4, the method may further comprise a step (S50) for the user selecting the data elements or accepting the default data elements, usually prior to the step (S100). This step may be related to the menu options mentioned above.

Referring to FIG. 4, the system action may be performed by the website 10 or the server 20. In certain embodiments of the invention, the system action may be performed by the user U, who accesses the website 10 or the server 20 using an appropriate information processing device such as computer or smart phone.

Group health insurance is quoted in all fifty states in a similar manner. In addition to general information about the group, insurance carriers require a “census”. The census is a list of the employees of the group with information about each employee that will be used to determine the quoted rates. This information generally consists of the following (for each employee):
Employee Name or ID
Employee Age or Date of Birth
Employee Home Postal Code
Employee Dependent Status (e.g. Employee+Spouse, Employee+Children, Family, etc.)

The traditional method for capturing this information is to ask the Group Administrator (or owner of the company{to manually gather this information from each employee. The Group Administrator then forwards the census to their agent, broker or directly to the carrier. Next the agent/broker/carrier or one of their employees either manually enters the census directly into a quoting system or imports the census, via Microsoft® Excel® or another mechanism, into the quoting system. Once the census is in the quoting system, a quote is run and the rates for the group are generated (generally in the form of a proposal).

Currently, the only means used by agents, brokers, and carriers to collect a census are as follows:
Ask the group to type the census information onto a paper document and fax, mail, or otherwise transmit that document to the agent, broker, or carrier.
Ask the group to type the census information into an electronic file format (e.g. Microsoft® Excel®, Comma Separated Values (CSV)®, etc.) and electronically transmit the electronic file to the agent, broker, or carrier for importing into the quoting system.

Currently, the methods with which the group gathers the census from the various employees to provide the collected information to the agent, broker, or carrier are as follows:
The group administrator or other employee polls each employee (in person, electronically or otherwise) asking for each of the data elements listed above then compiles the information into one of the formats listed above
The group collects the information from existing data systems (e.g. payroll) then compiles the information into one of the formats listed above
Some combination of the two methods above

The Affordable Care Act (ACA) has added, as a side effect of certain mandates, to the data that needs to be gathered for a census (for quotes effective Jan. 1, 2014 and later). In addition to the information listed above, the following must be gathered for the dependents of each employee:
Dependent Name (optional)
Dependent Age or Date of Birth
Dependent Home Postal Code (may not be required by some carriers)

The ACA mandates have significantly increased the amount of information that needs to be gathered for a group quote. Despite the additional informational requirements the census collection and gathering means have not changed.

The present invention offers a new method/tool for the gathering and collection of census data for the purpose of quoting group insurance. The following steps are performed:

1. A user of the system requests a unique hyperlink for a specific group. The same link is used by all employees of the group. Note: There may be a slightly different link to gather information from employees that are not eligible for the group's coverage but the same basic principal applies. In addition, the user may specify via a menu option which information is to be gathered from each employee for that particular group (there may also be a default list of fields).

2. The link is communicated to some or all of the employees by any means available (e.g. email, company intranet, verbal, w memorandum, etc.).

3. Each employee uses the hyperlink to access a webpage that polls them for the required information including but not limited to the information listed above. The webpage can generally be accessed by any device capable of browsing the internet (computer, mobile phone, tablet, etc.).

4. The employee enters their information into the webpage and saves it. The information is then stored directly on separate servers. Note: The group does not have direct access to the information. The group has access to a status page that allows the administrator (or agent/broker) to see the Name & Number of Dependents entered by each employee but not the rest of the information. In addition, the administrator (or agent/broker) can enter the detailed information (via the status page) for any employee that does not have access to the internet or otherwise cannot enter the information themselves.

5. Once all of the employees have entered their information, the administrator may notify the agent, broker, carrier or other user of the quoting system. An automatic means of notifying the agent/broker via a button on the status page is available but not necessary.

6. A user of the quoting system (agent, broker, carrier, a quoting company employee, or other) then logs in to the system and clicks a button to import the census from the separate servers directly into the quoting system. Alternatively, the user can export the census into an electronic file (Micorsoft Exel® or other) for transmittal directly to a carrier and eventual import or inputting into the carrier's quoting system.

The present invention is distinctly different from the prior arts as follows:
The solution gathers the census information directly from employees of a group (i.e. does not require the Group Administrator or Owner to gather the information).
The information is gathered via the internet.
The information collected is housed directly on the separate servers.
The solution generally does not require any data entry of detailed employee and dependent information on the part of the group administrator, agent, broker, or carrier. Note: It is possible to enter information on behalf of an employee but this is the exception rather than the rule.
The information can be imported directly from the separate servers into a quoting system or exported to another format.
The information is gathered directly from the employee in a secure environment that protects their Protected Health Information (PHI) per HIPAA regulations.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for gathering employee data for insurance quote including submission and/or enrollment, the method comprising steps for:
a user providing a website for a specific group in a group insurance comprising a plurality of employees or group of individual employees;
the user specifying selected information to be gathered from a group of employees;
the user sending a hyperlink information of the website to at least one of the plurality of employees;
at least one employee using the hyperlink information to access the website;
at least one employee entering the specified information, and a server storing and polling the information; and
an administrator of the specific group notifying the user of the completion of information entered by the employees.

2. The method of claim 1, wherein in the step for the user's specifying, the selected information to be gathered is specified using a menu option.

3. The method of claim 2, wherein the selected information comprises a default list of fields including an employee name or identification, an employee age or date of birth, an employee home postal code, and an employee dependent status.

4. The method of claim 3, wherein the selected information further comprises a dependent name, a dependent age or date of birth, and a dependent home postal code.

5. The method of claim 1, wherein in the step for the user's sending, the hyperlink information is sent using email, company intranet, verbal, or memorandum.

6. The method of claim 1, wherein in the step for the user's using the hyperlink information, the employee accesses the website through Internet using computer or mobile electronic devices.

7. The method of claim 1, wherein in the step for each employee's entering, the group of employees does not have a direct access to information stored in the server.

8. The method of claim 7, wherein the website comprises a status page showing a degree of completion of gathering information, which is allowed for the group of employees to access limited information including names and number of dependents entered by each employee.

9. The method of claim 8, wherein the administrator is allowed to enter detailed information for a specific employee.

10. The method of claim 1, wherein the user comprises an agent, a broker, a carrier, and others using the quoting system.

11. The method of claim 1, wherein in the step for the administrator's notifying, the notifying is set automatically.

12. The method of claim 11, wherein the notifying is implemented by clicking a button provided on the status page.

13. The method of claim 1, wherein the insurance comprises a health insurance, ancillary insurance, or other employee benefit.

14. The method of claim 1, further comprising a step for the user exporting the entered information.

15. The method of claim 1, further comprising a step for the user logging in an external quoting system, submission system, or enrollment system and importing the entered information from the server to the quoting system, submission system, or enrollment system.

16. The method of claim 15, further comprising a step for the user to use the gathered data within the said system for the purposes of quoting, submitting and/or enrolling employees or individuals for health insurance, ancillary insurance or other employee benefit.
